(19) United States
(12) Patent Application Publication
(10) Pub. No.: US 2010/0035471 A1
(43) Pub. Date: Feb. 11, 2010

(54) CONTACT CELL FOR ACCEPTING A CABLE END BY MEANS OF AN INSULATION PIERCING CONNECTION TECHNIQUE, AND METHOD FOR THE PRODUCTION THEREOF

(76) Inventor: Othmar Gaidosch, Ostfildern (DE)

Correspondence Address: K.F. ROSS P.C., 5683 RIVERDALE AVENUE, SUITE 203 BOX 900, BRONX, NY, 10471-0900, US

(21) Appl. No.: 12/160,809

(22) PCT Filed: Jan. 12, 2007
(86) PCT No.: PCT/EP07/00256

§ 371 Date: Sep. 28, 2009

(30) Foreign Application Priority Data
Jan. 14, 2006 (DE) 10 2006 001 898.2

(51) Int. Cl. H01R 13/40; B29C 35/08; B29C 67/00

(52) U.S. Cl. 439/625; 264/494; 264/463; 264/401

(57) ABSTRACT

The invention relates to a method for producing a plastic contact cell comprising a contact element (2) that is provided with an insulation piercing connecting device and is used for attaching one end of an electric cable in at least one contact chamber within the contact cell (1). According to the invention, the contact cell (1) is produced in a generative process in such a way that the contact cell (1) is constructed layer by layer from an amorphous starting material by irradiating the same with light. Also disclosed is a contact cell which is produced according to said method.

### FIELD OF THE INVENTION

The invention relates to a method of making a contact casing made of plastic and having a contact, an insulation displacement connector for fixing one end of an electric cable in at least one contact chamber in the contact casing, and to a contact casing produced using the method according to the preamble of claim 1.

### BACKGROUND

Increasing trends toward miniaturization and streamlining in all industrial sectors have made it necessary to correspondingly improve and miniaturize cable connection techniques. Since they are indispensable for connecting various components, cable connections continue to play an important role in the field of electronics.

Connecting to an unstripped conductor using a press-fit connector represents one of the most reliable and economical solder-free electrical connections. The insulated wire (the electrical cable, i.e. the metallic conductive core, surrounded by an insulating sheath) is pressed into a narrow slot in a terminal, and the flanks of the press-fit connector cut through the insulating sheath and compress the metallic conductive core so that a gas-tight connection results.

The conductor is generally introduced perpendicular to a plane defined by the flanks of the press-fit connector. Frequently, however, such as for the case of straight plug-in connections, it is necessary to introduce the conductor compactly flush with the slot direction. In this regard several approaches already exist in which the conductor is pressed into the slot not perpendicularly, but at an acute angle relative to the plane of the flanks, for example in DE 42 03 455 [U.S. Pat. No. 5,277,616], EP 0 886 156 [U.S. Pat. No. 6,113,420], DE 295 12 585 [U.S. Pat. No. 5,989,056], EP 1 158 611 [U.S. Pat. No. 6,676,436], or DE 103 23 615 [U.S. Pat. No. 5,341,473].

These involve so-called quick-connect techniques that allow the user to establish a durable electrical connection between unstripped electrical wires and corresponding contacts provided with press-fit connectors in a very economical manner and, if possible, without using tools.

These approaches share the common feature that the conductors that are to be pressed into the corresponding press-fit connectors are first inserted into chambers of a part made of an electrically insulating material. In this manner the conductors are positioned or fixed with respect to the press-fit connectors in such a way that, when they are pushed into their slots, the conductors are not pressed apart or back. Heretofore, all of these parts have been designed for manufacture by injection molding. In this process, melted plastic is injected under high pressure into sealed, temperature-controlled molds. After the melt hardens, the mold is opened and the molded parts are taken out.

Although injection molding has a number of advantages, it also has numerous limitations. Injection molding is in particular a mass-production process. Depending on the type of parts, economical manufacture is not possible unless there is a high production volume. Permanent dimensional stability of the parts is a function of various parameters such as environmental conditions, raw materials, machine settings, mold wear, and the like. The feeding of the molding material and the flow characteristics thereof inside the mold are crucial for the mechanical properties of the parts. Due to the differing orientations of the molecules in the flow direction or transverse thereto, the strength of the parts is anisotropic. Converging flow fronts, such as behind obstructions or when several sections are present, create joint lines that result in a significant loss of strength. In particular for several sections there is the risk of air inclusions. Such inclusions disappear, i.e. their mass is reduced, when the finished parts are cooled from processing temperature to room temperature. When this process occurs asymmetrically, additional distortion of the parts with respect to dimensional and shape stability may be expected. To minimize such process-related drawbacks to the greatest extent possible, injection-molded parts must be designed according to certain principles that in individual cases may conflict with one another or with regard to the function of the parts. Therefore, tradeoffs are generally necessary. The most important design guidelines are as follows: in principle, wall thicknesses of parts should be identical. If this is not possible, different thicknesses merge as smoothly as possible. In addition, the wall thicknesses should be selected to be as small as possible while taking into consideration the viscosity of the molding material. Mass agglomerations should be avoided as much as possible, since these may cause cavities, sink marks, warping, and the like. All surfaces situated in the demolding direction that are not absolutely functionally necessary must have demolding chamfers in order to easily remove the parts from the mold without damage. The same is true for lateral slides, if applicable. Undercuts are possible only by using complicated and very expensive molds having mold slides or jaws. Mold seams along surfaces cause ridges and misalignment of the molded part that for sealing surfaces, for example, may represent a serious quality defect. Holes and slots are provided in the demolding direction by use of corresponding cores in the mold. To keep the mechanical and thermal stresses on these cores within acceptable limits in the manufacturing process, certain guideline values must be taken into account: for example, a minimum diameter must not be below 1 mm, and a maximum aspect ratio (length/diameter) must not exceed approximately 5. Due to the risk of chipping, it is also important to ensure that the distance of holes from the edge of the molded part is not less than approximately half of the diameter of the holes. Of course, the problem of demolding bevels and undercuts also applies to holes, specifically, to an increasingly greater degree the closer the distance to the referenced limit regions.

With regard to the design rules to be taken into consideration for injection molding, compromises in shape are necessary in order to properly design contact casings produced by this method. At the same time, these types of molded parts cannot be scaled below certain dimensions. For example, miniature wires having diameters less than or well below a 1 mm limit cannot be produced in this manner.

Despite all of the described requirements as well as certain drawbacks, production of such contact casings using the injection molding process has become widely established. On the other hand, other processes, if known at all, have not gained acceptance, in particular because of the significantly higher material and/or process costs.

### DESCRIPTION OF THE INVENTION

The object of the invention, therefore, is to allow contact casings for a plug-in connector to be produced in a more flexible manner and with better quality with regard to conductors, compared to current approaches. A further aim is to develop the potential for appreciable miniaturization of this type of contact technology.

The invention further relates to a method of making contact casings provided with corresponding guide passages, and subsequently produced contact casings for contacting conductors using press-fit connectors, the conductors being pressed into the slot in the press-fit connector at an acute angle. Described below are examples of multipole flexible conductor holders produced by combining such contact casings using connecting ribs or other geometries and that are used to connect corresponding multiwire cables.

The most important functions and advantages resulting from the production method are as follows:
Receiving a conductor through an opening and precisely guiding same along a defined path, with the lowest possible frictional resistance, until an end stop is reached and the conductor is deflected from its longitudinal extension. Openings or interruptions along the guide passage, for example for inserting the press-fit connector, in principle should be kept as small as possible, and should be provided at their edges with rounded areas, bevels, or the like in order to prevent jamming of the conductor;
Receiving the press-fit connector through an oppositely situated opening and also guiding same in such a way that when the conductor is engaged the flanks of the press-fit connector cannot be pressed apart transverse to the penetration direction;
Also designing the guide passage in such a way that upon insertion into the press-fit connector the conductor is fixed in place solely due to the resulting restoring forces, and cannot be pressed apart or back in either the transverse or the longitudinal direction;
Spatially enclosing or isolating the contact pair comprising the conductor and press-fit connector in such a way that required minimum dimensions for clearances and creepage distances are maintained with sufficient reliability.

According to the invention, the generative method is mentioned as a possibility for making the contact casings described below. The generative method is a primary molding process in which a workpiece is generated in layers from an amorphous starting material (powders, liquids, and the like), using light, solely on the basis of the 3D data set for the workpiece. In the present case, the most important methods are those that produce highly filigreed, electrically insulating parts, for example stereolithography, microstereolithography, RMPD processes, and the like. On the basis of their CAD data the parts are generated in layers “from bottom to top” by curing a photoreactive polymer. This process is induced by irradiation with controlled, focused (ultraviolet) UV laser beams, or beams based on the two-photon effect (simultaneous absorption of two photons at a correspondingly high light intensity), by simultaneous illumination of entire respective layers, for example using DLP chips and the like.

The production method according to the invention has the following exceptional advantages with regard to the contact casings described below:
Functional prototypes and mass-produced parts are identical; i.e. initial prototype tests may be fully transferred to the production line;
Due to the very short process chain, the dimensional stability of the parts is influenced essentially only by the accuracy of the production unit and the properties of the photopolymer used;
As a result, and since only the 3D data set is required for operating the production unit, in principle the very time-consuming creation of drawings may be omitted at the design stage. Alternatively, for process monitoring, for example, relatively simple drawings with a few test dimensions would be sufficient;
The time- and cost-intensive review and approval of injection-molded parts that in practice usually entails considerable drawing and mold modifications, may also be omitted;
The shape and characteristics of the contact casings may be “custom-tailored” to the particular parameters of the conductor for individual customers or market trends in a very flexible manner. In principle, a lot size comprising a single item is conceivable;
In principle, within the scope of carrying out the method there are no constraints with regard to the freedom of design. Of particular interest are the possibilities for making undercuts, thin partition walls, and high aspect ratios; and
By use of PMPD technologies, for example, additional noteworthy advantages may be achieved with regard to material properties; for example, material properties (physical, chemical, optical, and the like) may be integrated into a component in the transverse as well as longitudinal direction with respect to the layer development (“RMPD® multimat” process). Of particular interest in this respect with regard to contact casings are combinations of various tribological and/or optical properties. Sealing surfaces may be provided on the component without subsequent assembly steps. Chemical resistance to given media may be produced in a targeted manner.

The invention, in particular contact casings of various designs produced using the method according to the invention, and contact supports for plug-in connectors formed from the contact casings are explained in greater detail below without limiting the invention thereto.

### BRIEF DESCRIPTION OF THE DRAWINGS

With regard to the coordinates shown in the following figures, the z axis always represents the feed direction of the conductor, whereas the axis z′ and, if applicable, the axis z″, pass through the center of the slot in the press-fit connector. Furthermore, the details and characteristics described for the following individual examples and Figures may be transferred to and/or exchanged with the remaining examples, depending on the possibilities for implementation and the particular requirements, as the result of which, of course, an additional number of variants of such examples are possible.

FIG. 1, FIG. 2, FIG. 3

### APPROACHES FOR CARRYING OUT THE INVENTION

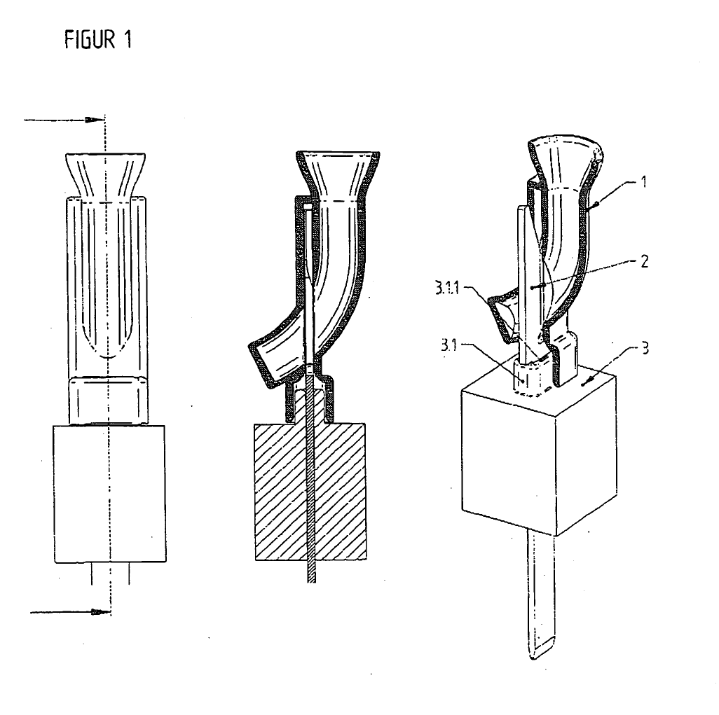

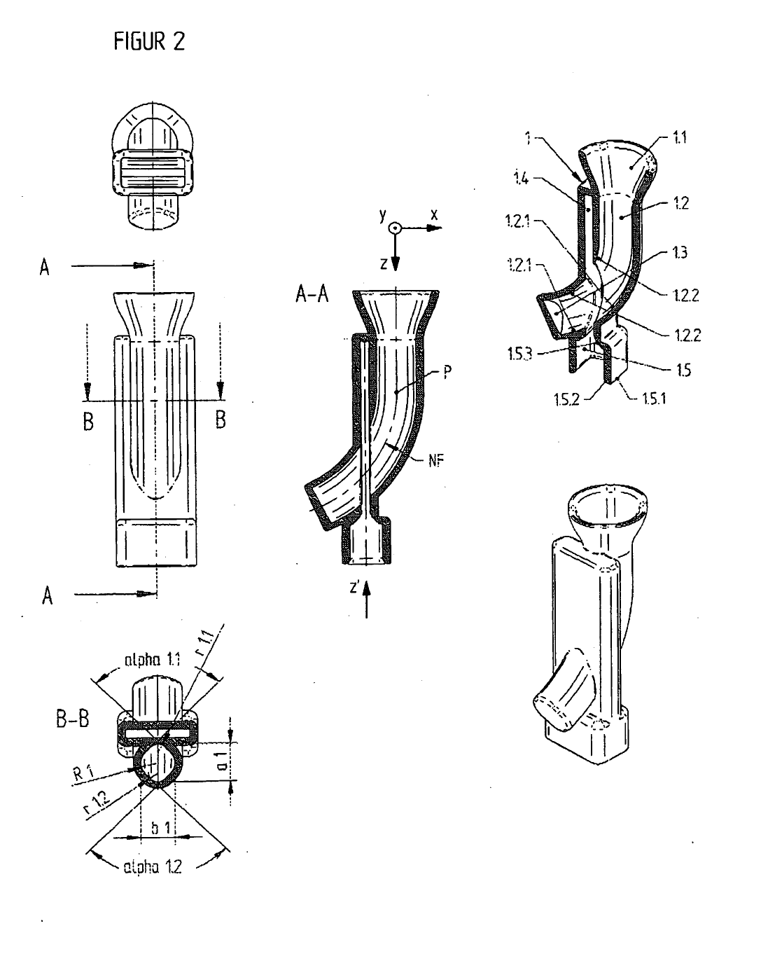

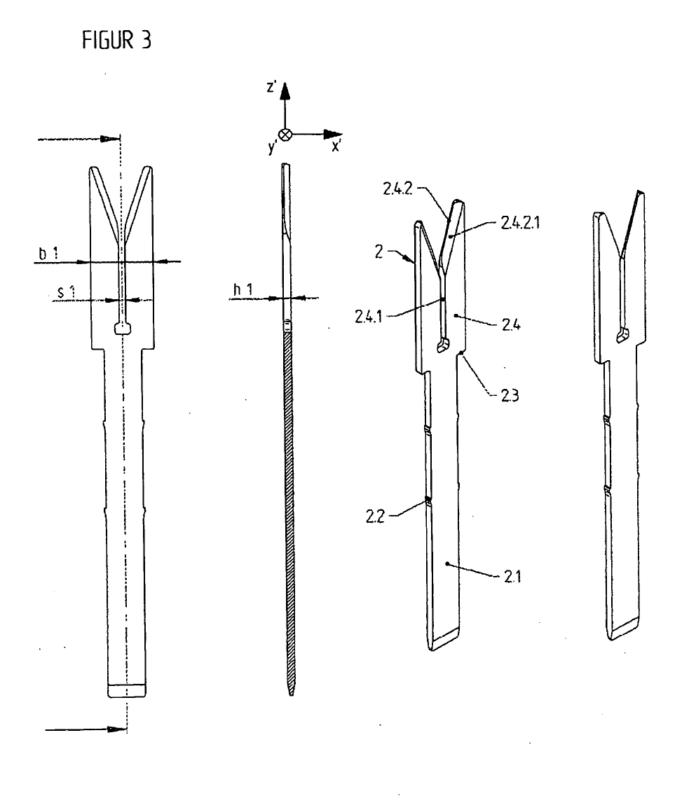

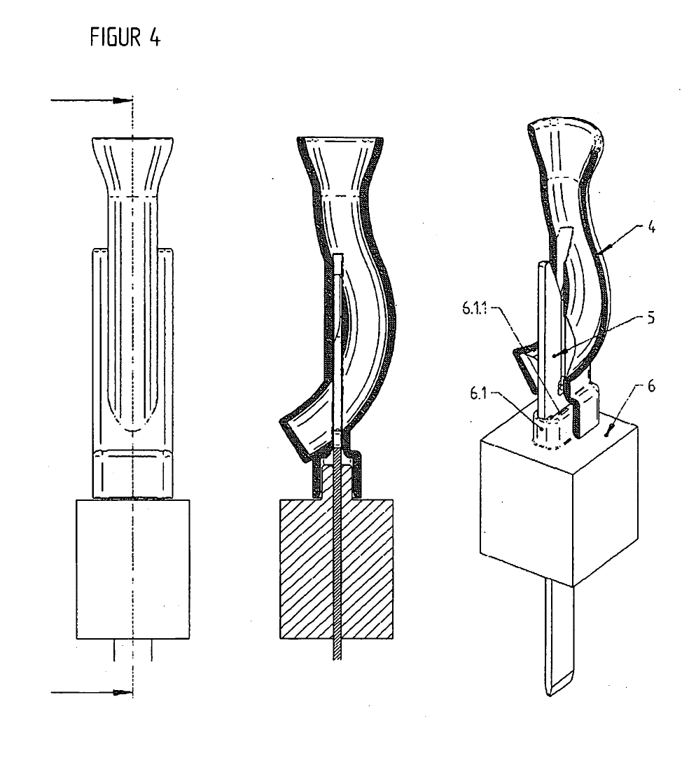

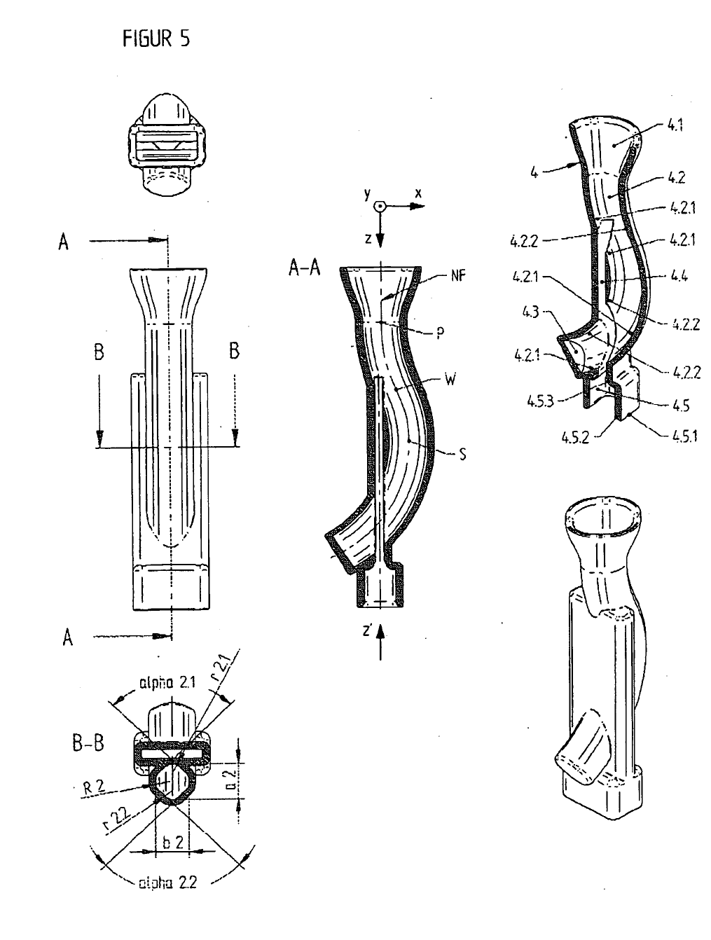

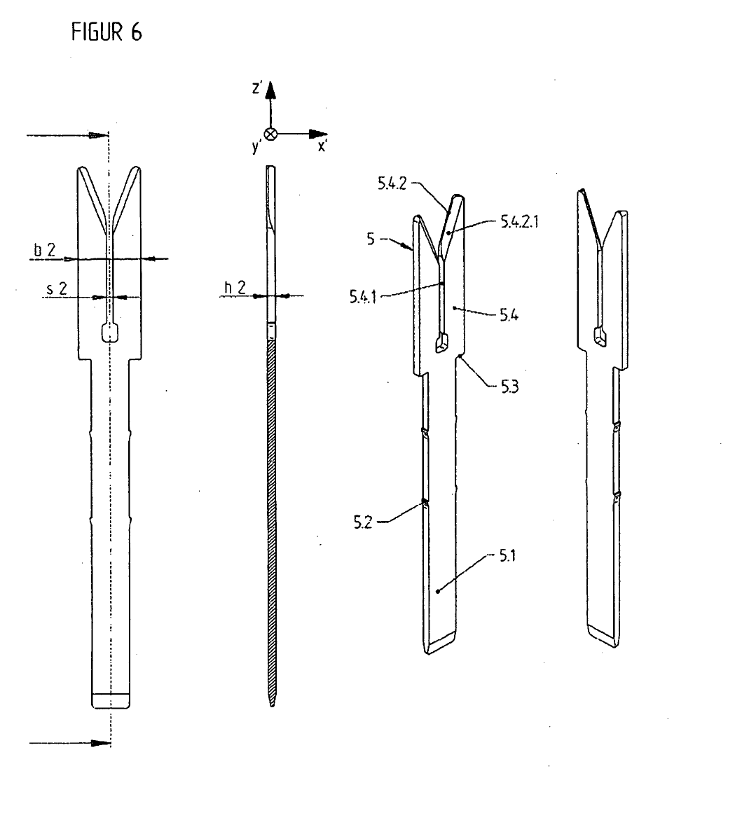

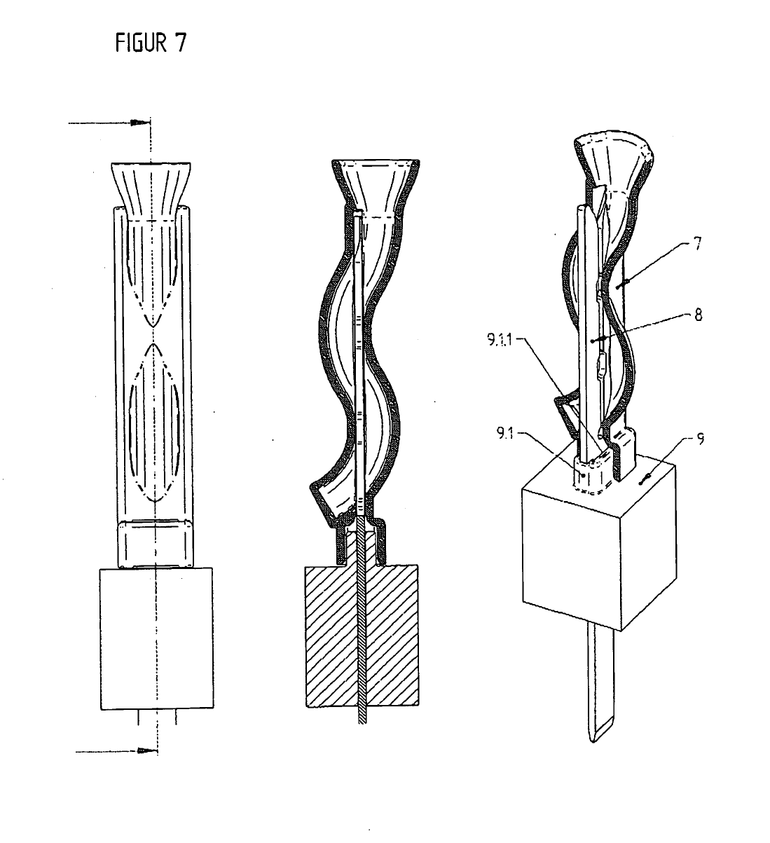

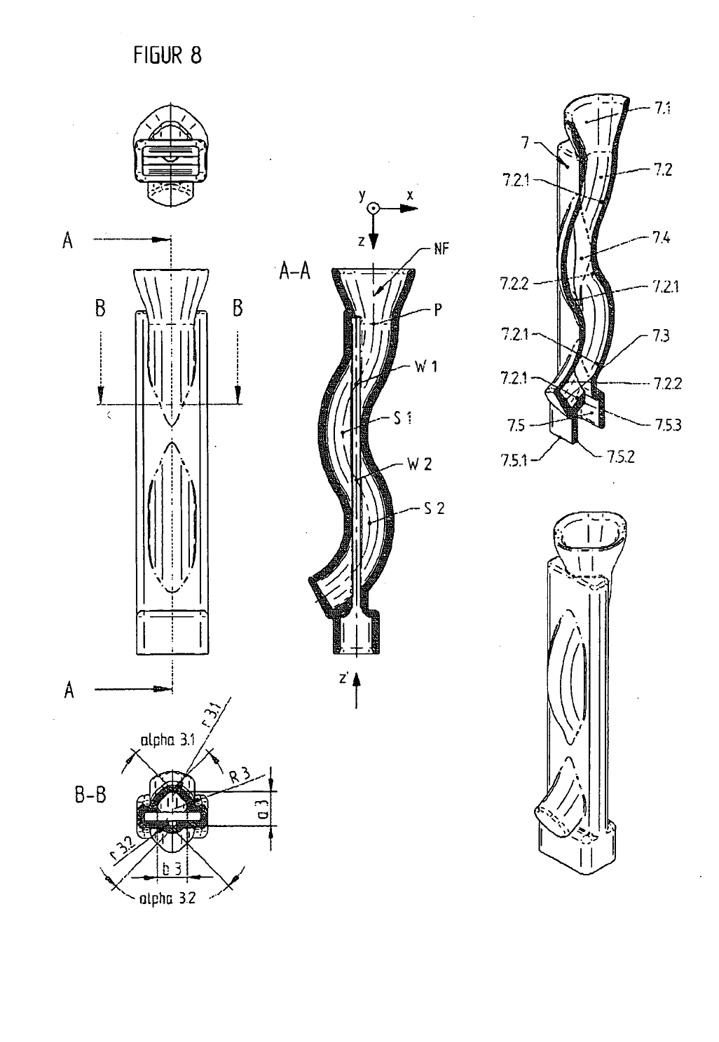

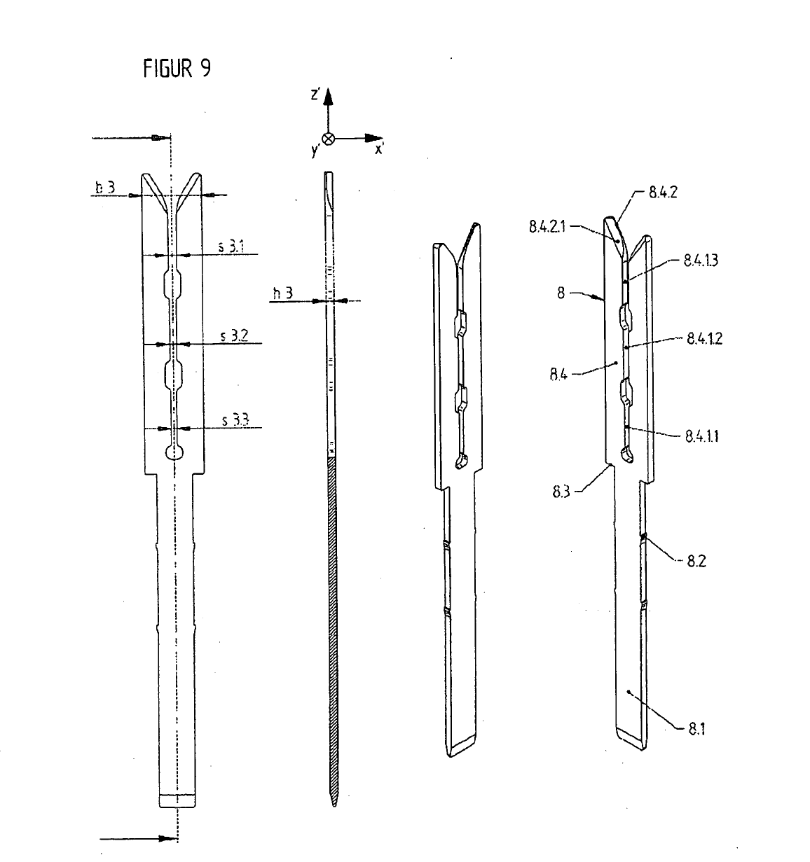

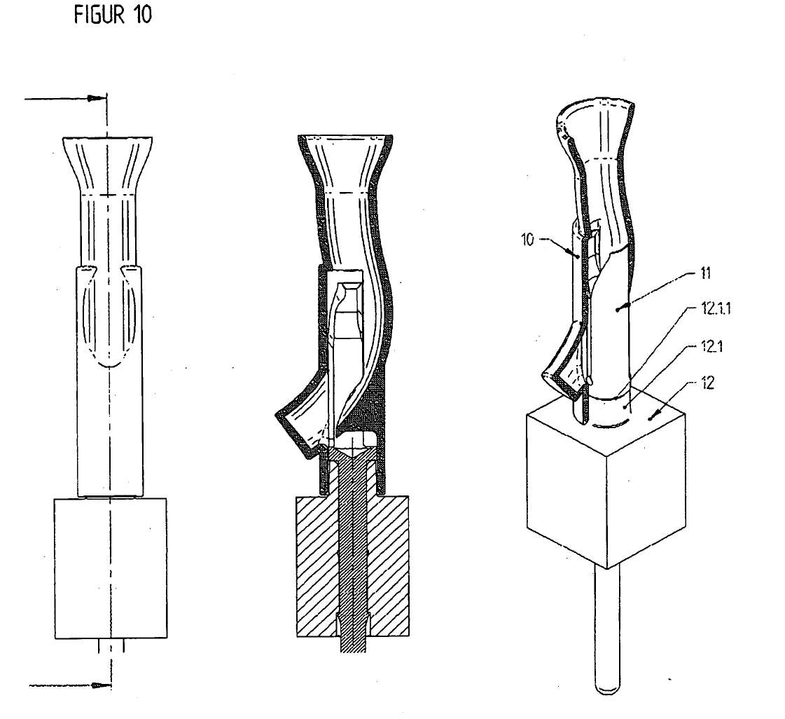

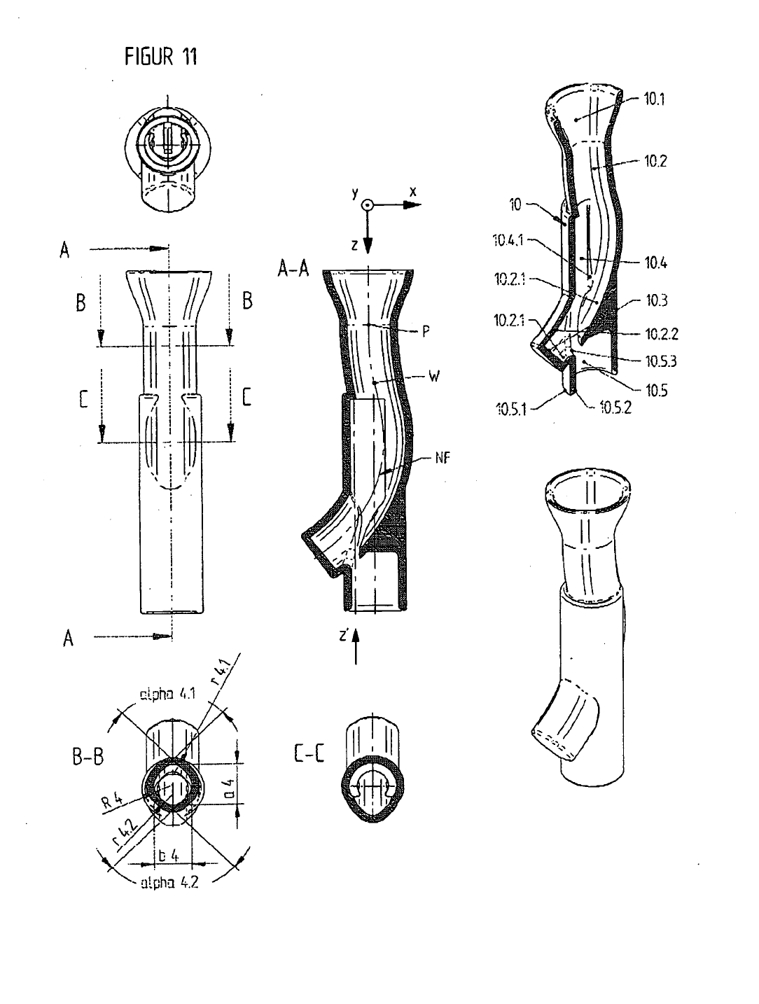

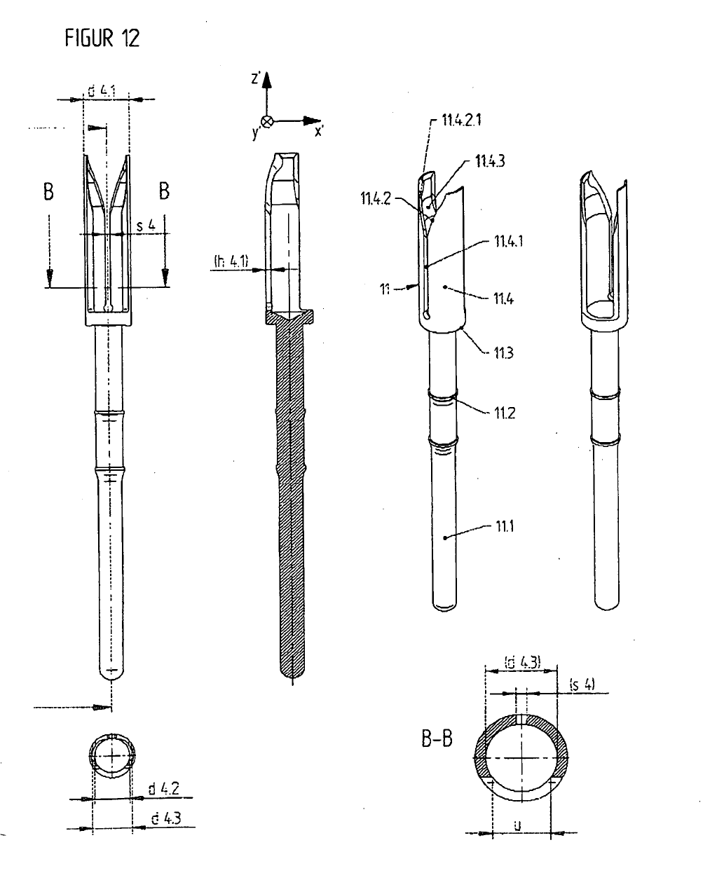

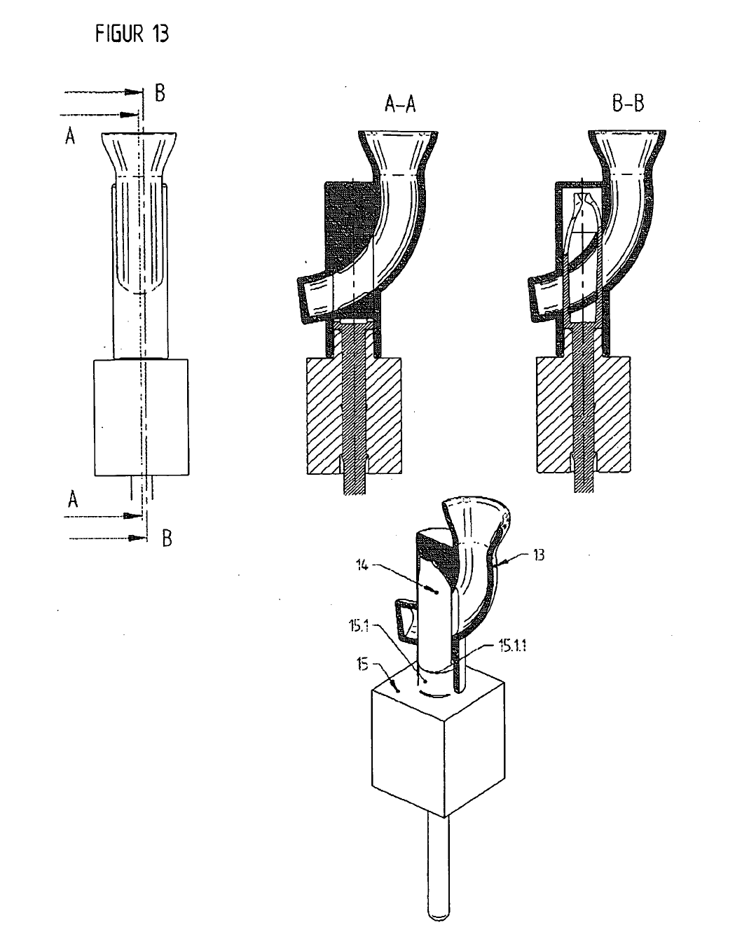

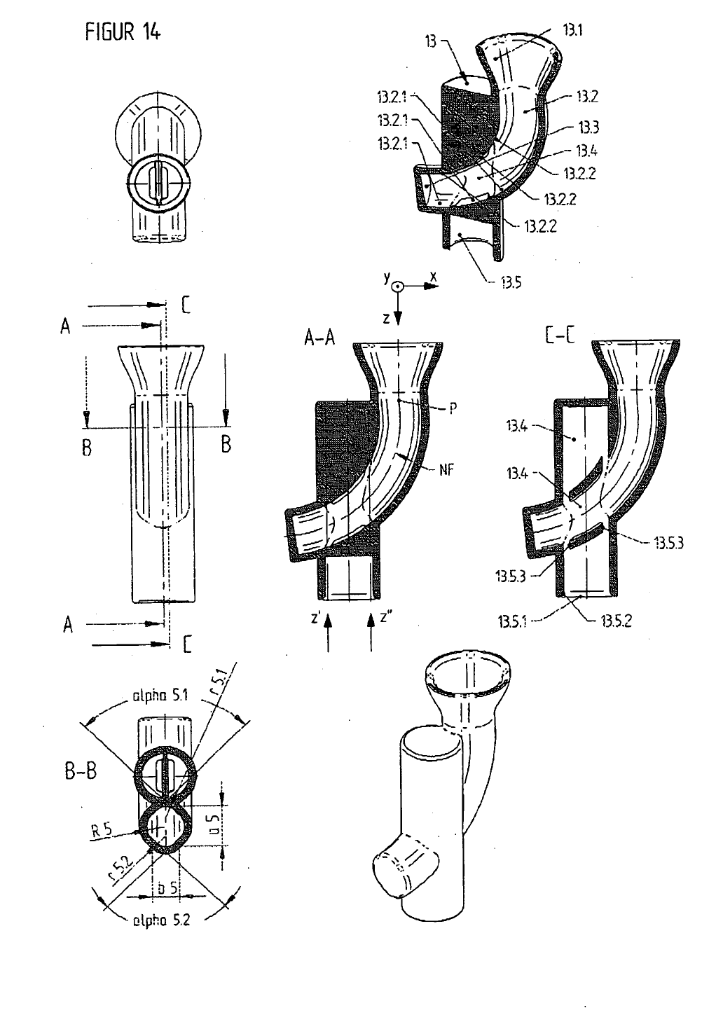

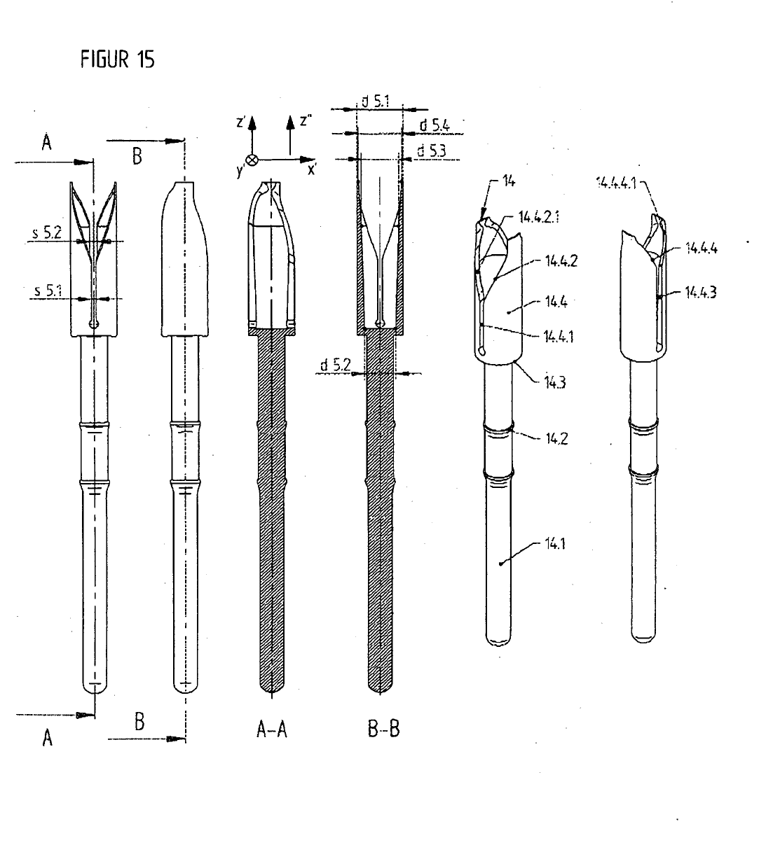

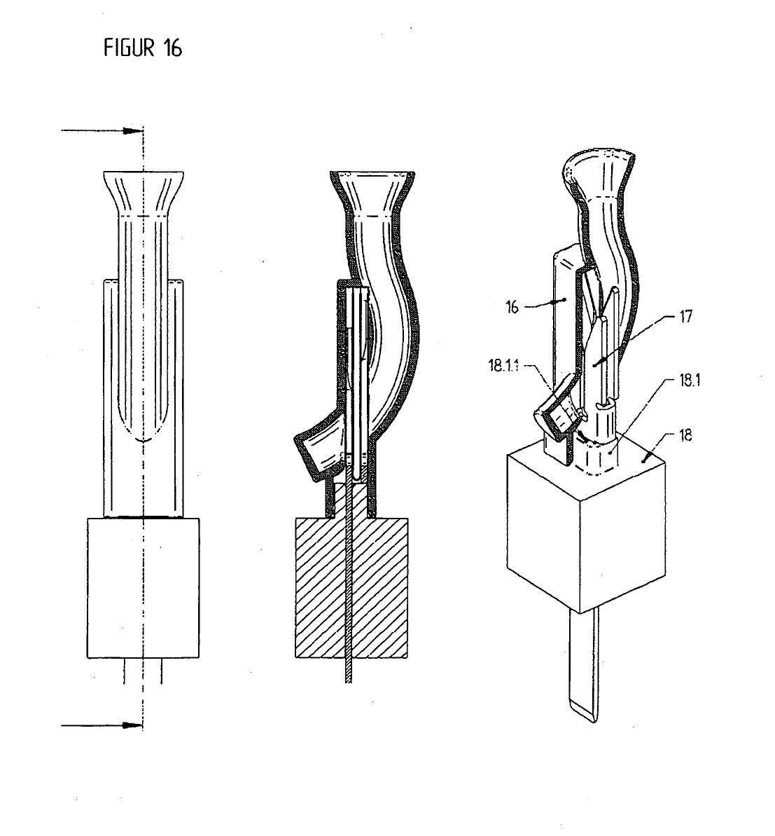

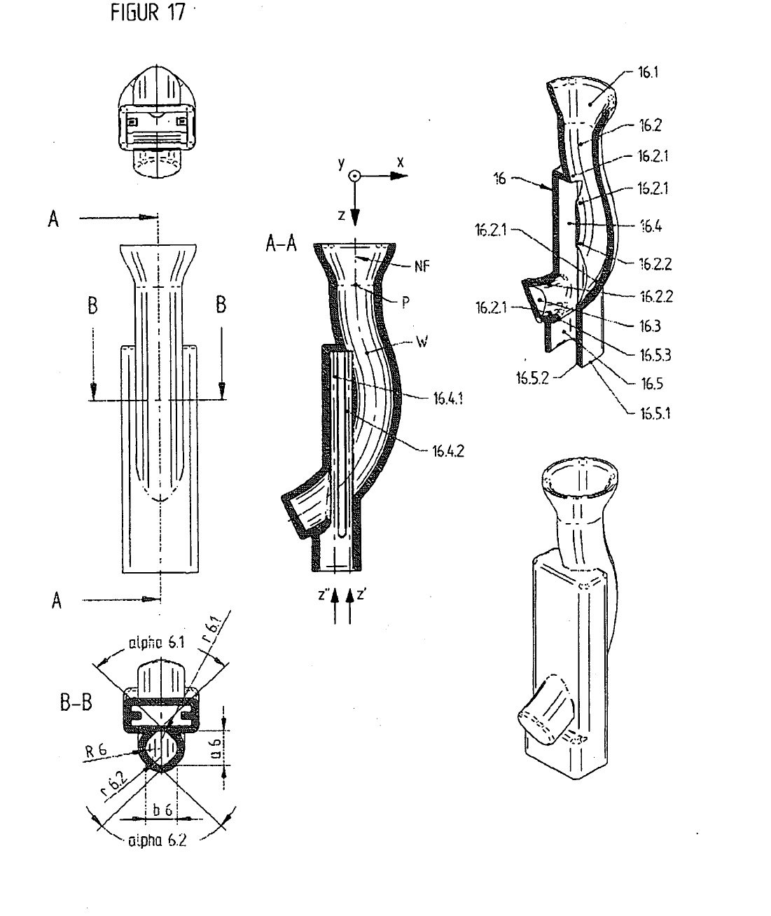

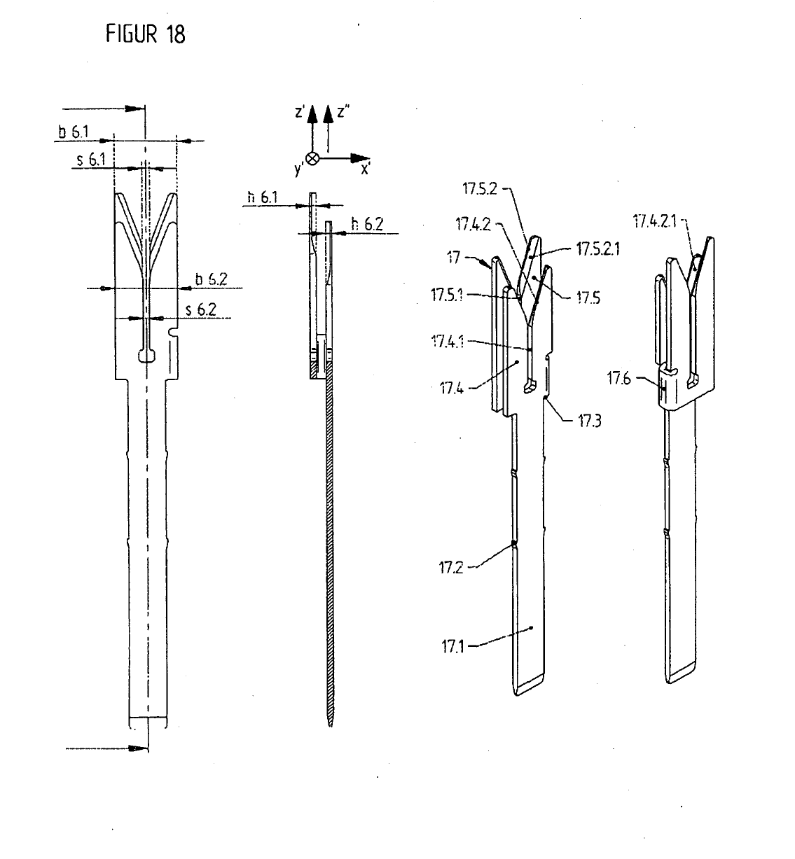

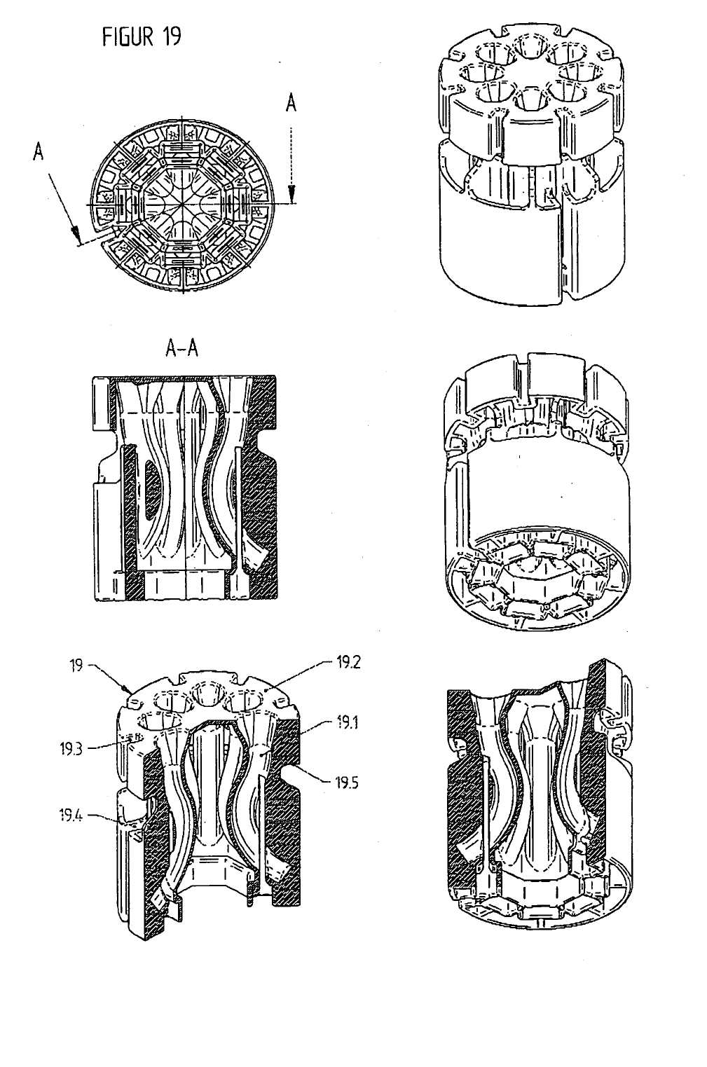

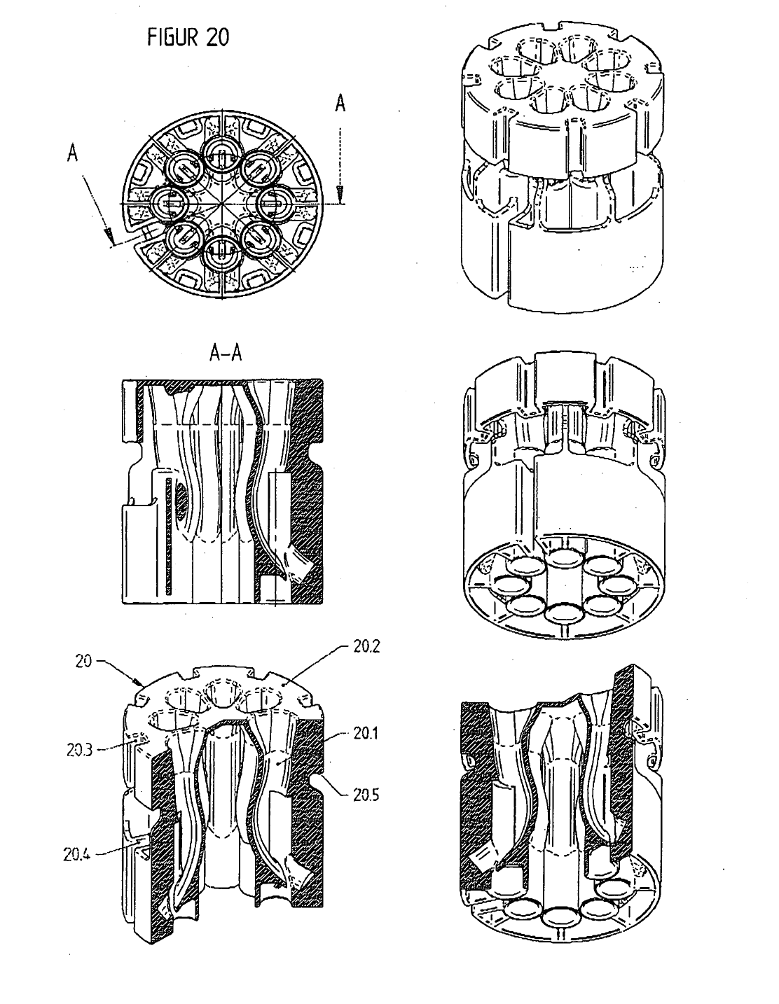

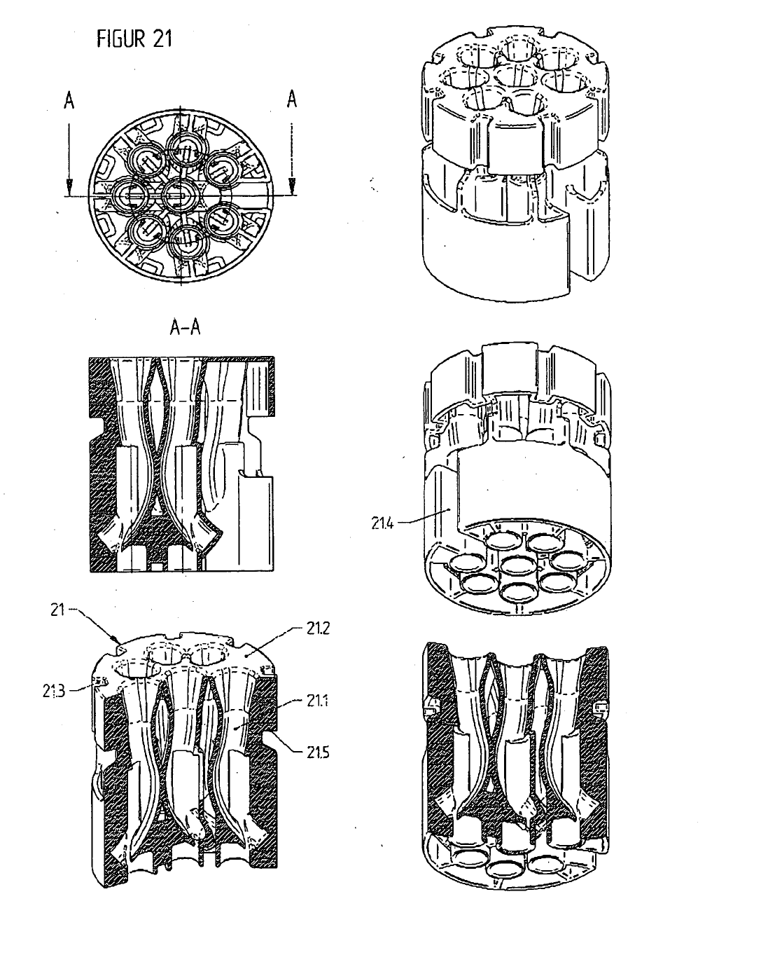

FIG. 1 shows a contact casing 1 that is part of an assembly comprising a contact support 3 and a contact 2 having a press-fit connector. Details of the contact casing 1 and the contact 2 are shown in FIGS. 2 and 3, respectively.

The function of the contact support 3, which is made of dielectric material, with respect to the contact 2 is to hold same in a defined manner, for example by extrusion coating, pressing, gluing, or the like. An important feature is the contact base 3.1 that has a stop or mounting surface 3.1.1 with respect to the contact 2 and that in shape and dimensions corresponds to a matching cavity 1.5 in the contact casing 1, such that the required minimum dimensions for clearances and creepage distances are maintained.

The contact casing 1 shown in FIG. 2, which also is made of dielectric material, has a funnel-shaped opening 1.1, a guide passage 1.2, an end stop 1.3, and a contact chamber 1.4, in addition to the cavity 1.5 previously mentioned.

The shape of the guide passage 1.2 and of the conductor (not shown) located therein of diameter D is characterized essentially by the shape of the neutral chamfer NF. In the present example, the neutral chamfer first runs straight in the z direction until point P, and then flows as a curve into the contact chamber 1.4, an x-z plane in which the neutral chamfer lies preferably also containing a z′ axis that passes through the center of the slot in the press-fit connector. The x-y projection of the guide passage 1.2 at point P as well as the x-y projection of the end stop 1.3 oppositely situated with respect to the axis z′ are positioned such that the metallic core of the wire is pressed with sufficient reliability into the slot in the connector that a secure electrical connection results. Due to the fact that the diameter of the metallic core is necessarily smaller than the diameter D of the conductor, in principle it is not absolutely necessary for the contact casing to have the same shape as in FIG. 2. In principle, a secure contact may also be achieved when the distance of the neutral chamfer from the axis z′ or from the center of the slot in the press-fit connector is less than D/2 at point P as well as at the end stop 1.3. It is thus possible to make such contact casings with very narrow designs that in particular allow correspondingly compact designs when several casings of this type are joined to produce multipole flexible conductor holders. Surfaces 1.2.1 and 1.2.2 that are inclined with respect to the axis z′, i.e. surfaces that begin at point P and end at the end stop 1.3, play an important role for the characteristics of the contact casing 1. The surfaces 1.2.1 that face in the z′ direction are used to deflect a conductor inserted through the opening 1.1 and upon which pressure is exerted in the z direction from its longitudinal extension along the neutral chamfer until reaching the end stop 1.3. Particular attention should be paid to the frictional forces generated between the conductor sheath and the surfaces 1.2.1. By minimizing these forces it is possible to reduce the radius of curvature of the neutral chamfer and to provide the contact casing with a correspondingly compact design. On the one hand, the pairing of materials is relevant in this regard. On the other hand, the aim is to set the surface microstructure of surfaces 1.2.1 with regard to the conductor sheath to the lowest possible coefficient of friction (key word: “lotus effect”). In turn, the function of surfaces 1.2.2 that face opposite the z′ direction is to fix a conductor located in the guide passage 1.2 in a force-fit manner, and optionally, according to the surface shape, also in a quasi-form-fit manner, in such a way that when it is pushed into the slot in the connector the conductor cannot be pressed back in the z′ direction or pressed apart in the x-y direction. With regard to the force-fit anchoring, in contrast to surfaces 1.2.2 previously mentioned it is advantageous to generate the highest possible frictional forces. Analogously to the situation described above, this may be achieved, once again with respect to manufacturing possibilities, by means of a corresponding surface microstructure and/or corresponding material properties partially limited to the surfaces 1.2.2 (for example, produced using the above-referenced RMPD® multimat process). Alternatively or additionally, the surfaces 1.2.2 may have a corrugated instead of a “smooth” design, so that the restoring forces generated when the conductor is pushed into the corresponding connector slot press the conductor sheath material into the cavities of this corrugation, thereby once again producing quasi-form-fit connections between the conductor sheath and the surfaces 1.2.2 at least one, preferably at many, locations. Several design possibilities, in principle, for such corrugations are shown in FIGS. 22 through 27, it being understood that variations and/or combinations as well as other embodiments of these examples are also possible. The shape and characteristics of the corrugation should be selected essentially as a function of the properties and dimensions of the particular conductor.

In the generic case, along the neutral chamfer the guide passage 1.2 has a cross-sectional shape (see FIG. 2, section B-B) that is formed by curved and/or polygonal sections, such that, depending on the application, this shape may be designed to be at least partially constant and/or at least partially variable along the neutral chamfer. With regard to the chamber installations, the smallest transverse dimension along this cross section must naturally always have clearance with respect to the diameter Dₘₐₓ of the largest wire to be connected. One possible design of this cross section is shown as an example in section B-B in FIG. 2. The cross section is of rhomboidal shape with rounded corners, having base dimensions a1 and b1, and in principle is suited for contacting wires of various thicknesses having diameters Dₘᵢₙ<D<Dₘₐₓ. Whereas a1 represents the distance between the vertices of surfaces 1.2.1 and 1.2.2 described above, b1 defines the distance between the surface lines or surface regions at the location where these surfaces merge, in a manner of speaking. The dimensional design of the shape that may be constant and/or variable along the neutral chamfer, as previously mentioned, is crucial for the characteristics of the guide passage with regard to its installation as well as the conductor contacting. Thus, although it is possible to provide wedge-shaped tapering to the ends defined by the dimensional, this is not absolutely necessary. As the result of such tapering along surfaces 1.2.1 and 1.2.2, on the one hand a conductor on which pressure is exerted along the axis z or z′ is centered toward the center of the chamber that is advantageous in particular for thinner conductors. To ensure this effect for all conductor diameters, however, it is important that the relationships 2*r_{1.1}<Dₘᵢₙ or 2*r_{1.2}<D be observed. On the other hand, the magnitude of the frictional forces generated in the chamber via such tapering may be significantly increased, specifically, to an extent for which the particular angle alpha 1.1 or alpha 1.2 is more acute.

According to the previous discussion concerning surfaces 1.2.1 and 1.2.2, it would be meaningful, if needed, to design alpha 1.1 to be relatively small along surfaces 1.2.2, and alpha 1.2 to be relatively large along surfaces 1.2.1. The dimension b1, in turn, depends on the conductor diameter D, so that when the conductor is pushed into the press-fit connector the ability of the conductor to spread laterally is minimized, so that b1>Dₘₐₓ must, of course, be valid. In the simplest case the guide passage 1.2 may also have a continuous circular cross section with a diameter 2*R1 that with regard to the conductor diameter Dₘₐₓ has only enough clearance to ensure problem-free installation.

The above comments regarding dimensions and shape of the chamber cross section are not limiting, either in their entirety or in any other manner. The intent is solely to demonstrate that numerous possibilities exist for adapting the functional characteristics of the guide passage to the particular properties of the conductors. Furthermore, it is not absolutely necessary (as shown in FIG. 2) for the individual cross sections to result in a constant progression of the guide passage lateral surface(s), i.e. along the neutral chamfer. Depending on the requirements, along their longitudinal extension these lateral surfaces may have a constant progression, at least partially, and/or a more or less pronounced step-shaped progression, i.e. provided with gap-like recesses, at least partially.

Another important part of the contact casing 1 is the contact chamber 1.4. The function of the contact chamber is to accommodate flanks 2.4 of the press-fit connector and at least partially guide same in such a way that the flanks cannot be pressed apart in an undefined manner in either the x or y direction as the result of the restoring forces generated when the conductor is pushed in. To keep friction that is generated between the flanks 2.4 of the press-fit connector and the contact chamber 1.4 as low as possible, the same considerations described for the guide passage surfaces 1.2.1 apply. As previously mentioned, it is also important to ensure that the edges of perforations produced in the guide passage 1.2 by the contact chamber 1.4 are designed in such a way that jamming of the conductor, in particular during installation in the chamber, is prevented. Furthermore, in principle the aim is to keep the x-y projections of these perforations as small as possible. In addition, the extension of the contact chamber 1.4 along the axis z′ must be at least as long as the particular penetration depth of the press-fit connector 2 into the contact casing 1.

The cavity 1.5 in the contact casing 1 is used to accommodate the contact base 3.1, and, together therewith, to maintain the necessary clearances and creep distances. To this end, the cavity has an opening 1.5.2 provided with insertion bevels and a stop surface 1.5.1 with respect to the contact support 3. For insertion of the flanks 2.4 of the press-fit connector the cavity has an additional opening 1.5.3, also provided with insertion bevels toward the contact chamber 1.4.

FIG. 3 shows a contact 2 designed as a flat contact pin 2.1 at the opposite end of the conductor connection, but that, depending on the application, may also be designed as a round contact pin, contact bush, hybrid contact, semiconductor contact, solder contact, or the like. The contact 2 is provided with projections 2.2 for anchoring in an insulating support. The surfaces 2.3 are used as an installation stop and for absorbing the forces generated when the conductor is pushed into the press-fit connector. Toward the conductor the contact 2 is designed as a flat press-fit connector having cross-sectional dimensions b1 and h1 and having at least two flanks 2.4 in the press-fit connector, the slot in the press-fit connector 2.4.1 therebetween having the width s1 and having insertion bevels 2.4.2 that with regard to the conductor have a centering effect and also contribute to a reduction in penetration forces. An additional reduction of these forces is achieved when the insertion bevels 2.4.2 are provided with edge bevels 2.4.2.1, either on one side of the respective edge, as shown in FIG. 3, or also on both sides. The slot 2.4.1 in the press-fit connector between the flanks 2.4 may have a constant width s1 corresponding to the metallic core of the conductor. However, designs in which the progression of the slot 2.4.1 has the same width, at least partially, and/or a decreasing and/or increasing width, at least partially, are also possible. The slot 2.4.1 may have, for example, a straight, stepped, undulating, or serpentine progression. Another interesting design with regard to all of these variants results when the slot width s1 is not constant, but instead is variable, in particular V-shaped, along the length of the slot, so that at its base the slot is slightly narrower than at the insertion bevels 2.4.2. This design is particularly important for contacts in which the conductor defines an acute angle relative to the slot in the press-fit connector, since in this case a correspondingly greater contacting length results than for transversely positioned conductors. Since with regard to the contact quality there is a fixed relationship between the diameter of the metallic core of the conductor and the slot width s1, as the result of such a V-shaped slot optimal contact toward the slot base would preferentially be provided by thinner metallic conductors, whereas at the tip optimal contact would preferentially be provided by thicker metallic conductors, thereby correspondingly expanding the application spectrum for such press-fit connectors. In addition, for stamped or lasered press-fit connectors, for example, also for improving the contact quality and/or expanding the application spectrum, the individual edges of the connector slot 2.4.1 may have the same or different designs, and may be designed as steps or the like that are straight, at least partially, and/or are provided in the form of very flat serpentine lines, at least partially merging flatly into one another, and in addition the slot width s1 may be either constant or variable. In addition, by use of such measures the conductor is effectively hindered or prevented from being pressed back in the longitudinal direction after contact has been made. Furthermore, the orientations of the boundary surfaces of the slot 2.4.1 in the press-fit connector, the insertion bevels 2.4.2, and the edge bevels 2.4.2.1 in the plane x′-y′ along the longitudinal extension z′ of these regions may be designed to be constant, at least partially, and/or variable, at least partially. It is also possible for the edge bevels 2.4.2.1 to extend not only at least partially along the region of the insertion bevels 2.4.2, but to also be provided, at least partially, along the slot in the press-fit connector, thereby allowing the penetration force characteristics to be further optimized. Of course, the edge bevels 2.4.2.1 may also be omitted completely.

As previously noted, the descriptions for FIGS. 1, 2, 3 analogously apply as well to the following figures, in which further design possibilities of such contact casings and associated press-fit connectors are disclosed. An in-depth description is provided, with emphasis on the differences or newly added details with respect to the previous example.

FIG. 4, FIG. 5, FIG. 6

FIG. 4 shows a contact casing 4 that is joined to an assembly group comprising a contact support 6 and a contact 5.

Details of the contact casing 4 and contact 5 are shown in FIGS. 5 and 6, respectively.

The difference from the example from FIGS. 1, 2, and 3 consists in the design of the contact casing 4 shown in FIG. 5, specifically, in the progression of the guide passage, i.e. the neutral chamfer, of the contact casing. In the present example, the neutral chamfer also first runs straight in the z direction until point P, but then forms a curve directed away from the contact chamber 4.4 that in turn at inflection point W merges with by a curve having a vertex S and that then intersects the contact chamber 4.4 similarly as in the previous example. Here as well, the x-y plane in which the neutral chamfer lies also preferably contains the axis z′ that passes through the center of the connector slot. Analogously to the previous example, the x-y projection of the guide passage at the vertex S as well as the x-y projection of the end stop 4.3 oppositely situated with respect to the axis z′ are positioned such that the metallic core of the conductor is pressed with sufficient reliability into the slot in the press-fit connector that a secure contact results. As the result of a neutral chamfer extending in this manner, on the one hand a conductor that is deflected more frequently from its longitudinal extension before being pressed into the connector slot in the press-fit connector generates a higher retaining or frictional force within the contact casing 4, due to the residual elasticity of the conductor, than in a comparable contact casing 1. On the other hand, much higher buckling stresses are produced within the conductor in the contact casing 4 when the conductor is pressed into the connector slot, thus creating additional retaining or frictional forces at the side walls of the guide passage 4.2. As a result, for a specified retaining force the transverse extension of a contact casing 4 along the x axis may have a correspondingly more compact design than is the case for a contact casing 1. Of course, contact casings having guide passages are also conceivable in which the neutral chamfer of the guide passage has two or any given number of inflection points W, and thus has a correspondingly higher number of curved sections than described in the present example. Furthermore, such guide passages may also be designed in such a way that their neutral chamfers are composed at least partially of generally curved sections and/or at least partially of generally polygonal sections, whereby the progression thereof may have a continuous as well as a discontinuous design.

FIG. 7, FIG. 8, FIG. 9

Like the previous examples, FIG. 7 shows a contact casing 7 that is joined to an assembly group comprising a contact support 9 and a contact 8. The guide passage 7.2 of the contact casing 7 in FIG. 8 has a neutral chamfer with two inflection points W1, W2 and two corresponding vertices S1, S2. The special characteristic of this contact casing lies in the fact that along its longitudinal extension along the axis z′ the contact chamber 7.4 intersects the progression of the guide passage 7.2 three times, i.e. the neutral chamfer thereof that in cooperation with the press-fit connector for the contact 8.4 allows a corresponding triple contact with the metallic core of a conductor located within the chamber. To ensure secure contacting, here as well it is important to correctly position the x-y projections of the end stops 7.3 and the cross sections of the guide passage at vertices S1, S2 and at point P.

Along the flanks 8.4 of the press-fit connector the contact 8 shown in FIG. 9 has three contact regions or press-fit connector slots 8.4.1.1, 8.4.1.2, and 8.4.1.3, the longitudinal orientation of which along the axis z′, as shown in FIG. 7, corresponds to the regions in which the conductor is contacted within the guide passage 7.2. With regard to the contact 2, the comments made under item 2.2.1 concerning the design details for the press-fit connector analogously apply in the present case for each of the contact regions 8.4.1.1, 8.4.1.2, and 8.4.1.3, and, of course, for the insertion bevels 8.4.2 and edge bevels 8.4.2.1 as well. In addition, it is understood that these contact regions do not necessarily have to be separated from one another in a defined manner, as shown in FIG. 9, since uniform connector slots are also possible that may have one or all of the features previously described.

Compared to the conductor on one side, the cooperation of such a contact casing 7 with an associated contact 8 has the advantage that the redundancy, and thus the reliability, of the electrical connection is correspondingly increased to the extent that the conductor is multiply contacted. Furthermore, with regard to the contact closest to the end stop 7.3 (in the present example, the contact at the slot in the press-fit connector 8.4.1.1) the [contacts] that respectively follow along the axis z′ act, in a manner of speaking, as strain relief, thereby increasing the operational reliability of such a connection, in particular under severe environmental conditions. In addition, such a several contact on the same conductor correspondingly reduces the associated flow resistance compared to a single contact. If the contact 8 is also designed as shown in FIG. 9, so that the individual contact regions 8.4.1.1, 8.4.1.2, and 8.4.1.3 have the same or different slot widths s3.1, s3.2, and s3.3, respectively, preferably with s3.1>s3.2>s3.3, in this manner conductors having approximately the same sheath diameters but having a relatively wide distribution of metallic core diameters may be contacted within the same chamber that naturally further expands the application spectrum of such a configuration.

On the basis of this example it may be generally concluded that the number of locations along the axis z′, i.e. regions at which a conductor situated within a guide passage is sequentially contacted by means of a press-fit connector, must be at least one, but may be any given number as needed.

FIG. 10, FIG. 11, FIG. 12

FIG. 10 shows the contact casing 10 that is joined to the assembly group comprising the contact support 12 and the contact 11.

The special characteristic of this example consists primarily in the design of the contact 11 from FIG. 12. The contact 11 is provided at the opposite end of the conductor connection in the form of a round contact pin 11.1, but that, depending on the application, may also be designed as a flat contact pin, contact bush, hybrid contact, semiconductor contact, soldering contact, or the like. The contact 11 is provided with projections 11.2 for attachment in an insulating support. Surfaces 11.3 are used as an installation stop and for absorbing the forces generated when the conductor is pushed into the press-fit connector. Toward the conductor the contact 11 is designed as a press-fit connector having at least two flanks 11.4, the slot 11.4.1 in the press-fit connector therebetween having the width s 4, and having insertion bevels 11.4.2 that with regard to the conductor have a centering effect and also contribute to a reduction in the penetration forces. An additional reduction of these forces is achieved when the insertion bevels 11.4.2 are provided with edge bevels 11.4.2.1. With regard to the slot 11.4.1 in the press-fit connector, the insertion bevels 11.4.2, and the edge bevels 11.4.2.1, the comments made concerning the press-fit connector for the contact 2 (see FIG. 3) apply here as well.

The flanks 11.4 of the press-fit connector shown in FIG. 12 have the cross-sectional shape of annular segments, wherein the dimension u may be equal to or slightly less than the diameter of the conductor D to be contacted. When u<D, the conductor contacted via the edges of the slot 11.4.1 in the press-fit connector defined by the dimension u act, in a manner of speaking, as strain relief. The orientation of the edges at dimension u does not necessarily have to correspond to the illustration in FIG. 12, and may have any given orientation in the x′-y′ plane, depending on the application. With regard to the flank cross sections, annular segments represent only one particular embodiment of the generic case, according to which these cross sections have a shape that is uniformly curved (for example, ellipsoidal or parabolic sections or the like), at least partially, and/or nonuniformly curved, at least partially. In addition, basic shapes are possible that are formed by polygonal sections that are uniform, at least partially, and/or nonuniform, at least partially (an L shape, for example), or also formed by combinations of such curved and polygonal sections.

Press-fit connectors having such flanks that are at least partially closed (see FIG. 12) have the significant advantage compared to flat-surfaced press-fit connectors (see FIGS. 3, 6, 9) that the former have much smaller dimensions in the y′ or y direction with regard to a specified elastic rigidity as well as a current density to be conducted. The supposed disadvantage, that this type of connector requires correspondingly more installation space along the x′ or x axis, has little or no relevance with respect to the manner that this installation space is provided within the x-y projection surface that is necessary anyway for the respective guide passage 10.2 (see FIG. 11). With regard to a compact design, basically it may be concluded that, for the same or comparable functional thickness, contact casings for, or with, press-fit connectors having flanks that are at least partially closed (see FIGS. 10, 11, 12) require considerably less installation space along their x-y cross section than contact casings having flat-surfaced connectors.

Furthermore, for such press-fit connectors it is possible to align the lateral surface(s) of the press-fit connector flanks 11.4 in parallel, at least partially, and/or at an angle or perpendicular to the axis z′, at least partially. As shown on the contact 11 by way of example in FIG. 12, the inner surface 11.4.3 may be provided, for example, from two cylindrical partial surfaces having diameters d4.2 and d4.3, in addition to a conical connecting surface provided in-between. When d4.2>d4.3, it is possible to achieve better centering of the conductor before pressing it into the press-fit connector, and in particular the penetration forces may also be reduced. On the other hand, when d4.2<d4.3, more or less effective strain relief may be achieved with regard to a contacted conductor, depending on the degree of inclination of the conical surface relative to the axis z′. Of course, the number, positioning, and sequence of such partial surfaces do not necessarily have to correspond to the illustration in FIG. 12, and may be defined according to the particular application. Similarly, functional characteristics may also be influenced via the outer surfaces of the connector flanks 11.4, specifically, in interaction with the surfaces of the contact chamber 10.4 with which they are associated. Thus, for example, it would be possible to produce targeted stress characteristics for the contacted conductor along the slot 11.4.1 in the press-fit connector by appropriately positioned projections on these outer surfaces that are slightly oversized with respect to the contact chamber 10.

The contact casing 10 shown in FIG. 11 is similar to the contact casing 4 shown in FIG. 5, except that the contact chamber 10.4 and the cavity 10.5 are adapted to the previously described contact 11. Emphasis is placed once again on the contact chamber guide surfaces 10.4.1 that via the dimension u correspond to the edges defined at the flanks 11.4 of the press-fit connector and prevent the edges from being pressed apart in the x direction when the conductor is pushed into the connector slot.

FIG. 13, FIG. 14, FIG. 15

FIG. 13 shows the contact casing 13 that is joined to the assembly group comprising the contact support 15 and the contact 14.

The example shown in these FIGS. is similar to that shown in FIGS. 10, 11, and 12. The difference once again lies in the design of the flanks 14.4 of the press-fit connector for the contact 14, and, of course, the design of the corresponding contact chamber 13.4 at the contact casing 13.

In the present case, the flanks 14.4 of the press-fit connector on the contact 14 are designed in such a way the edges of the connector flanks that correspond to the above-described dimension u of the contact 11 and that in the present case are defined by dimension s5.2, are brought so close together that, in addition to the slot 14.4.1 in the press-fit connector a second connector slot 14.4.3 is provided. Corresponding to these slots 14.4.1 and 14.4.3, the contact 14 also has two respective insertion bevels 14.4.2 and 14.4.4, each with two edge bevels 14.4.2.1 and 14.4.4.1. The particular sequence in which these bevels penetrate the conductor may be defined via the position of the insertion bevels 14.4.2 and 14.4.4 along the z′ or z″ axis, with reference to the respective inclination of the neutral chamfer of the guide passage 13.2 in the region of the contact chamber 13.4.

Compared to the example from FIGS. 7, 8, 9 under item 2.2.3, in which double or multiple contacting of the conductor along the axis z′ is achieved, by use of such a press-fit connector for a contact 14 it is possible to contact a conductor at least twice along the axis x or x′. With regard to the slot widths, the relationships s5.1>s5.2, s5.1=s5.2, or preferably s5.1<s5.2 may apply. For such an at least double contacting along the axis x or x′, the same comments made above apply with regard to contact redundancy and reliability, strain relief, flow resistance, and an expanded application spectrum.

Of course, when the design details or characteristics from the examples in FIGS. 7, 8, 9 and FIGS. 13, 14, 15 that are necessary to this end are appropriately combined, embodiments are conceivable in which the conductor may be simultaneously doubly or multiply contacted in the z, z′, or z″ direction as well as in the x or x′ direction.

With regard to the design of the cross sections of the flanks 14.4 of the press-fit connector as well as the inner and outer lateral surfaces thereof (in FIG. 15 the inner lateral surface is shown by way of example as being formed by two conical surfaces defined by the dimensions d5.2, d5.3, and d5.4), once again the same comments apply that were previously made concerning the contact 11 from FIG. 12.

FIG. 16, FIG. 17, FIG. 18

FIG. 16 shows the contact casing 16 that is joined to the assembly group comprising the contact support 18 and the contact 17.

In principle, this example is very similar to that shown in FIGS. 13, 14, and 15, with the special feature that in the present case the contact 17 has an at least double press-fit connector with flat-surfaced flank pairs 17.4 and 17.5, and has respective connector slots 17.4.1 and 17.5.1, insertion bevels 17.4.2 and 17.5.2, and corresponding edge bevels 17.4.2.1 and 17.5.2.1, the individual press-fit connectors being joined together via the connecting loop 17.6.

The advantage of such a design that is preferably produced using a stamping technique, is that by use of such connecting loops 17.6 or a spiral-shaped repetition thereof it is very easy to successively position at least two, or a plurality, of such individual press-fit connectors on a contact 17 along the x′ axis, by means of which along this direction a corresponding number of contacts may be established at one conductor.

Corresponding to these individual press-fit connectors for the contact 17, the contact casing 16 from FIG. 17 has individual contact chambers 16.4.1 and 16.4.2 that are separated from one another by ridges in such a way that when the conductor is pushed into the slot in the press-fit connector, within each contact chamber the connector flanks are prevented from pressing apart with respect to the axis x′ as well as the axis y′. Of course, these ridges must be designed with respect to their transverse projection along the y axis so that they do not protrude into the progression of the guide passage 16.2, thereby damaging or hindering the installation thereof in the guide passage.

In this case as well, by combining the corresponding design details or characteristics from the examples in FIGS. 7, 8, 9 and FIGS. 16, 17, 18 it is possible to provide designs in which the conductor may be simultaneously doubly or multiply contacted in the z, z′, or z″ direction as well as in the x or x′ direction.

FIG. 19, FIG. 20, FIG. 21

These FIGS. show examples of various multipole flexible conductor holders 19, 20, 21 that are formed by several contact casings 19.1, 20.1, 21.1 joined together by ridges and similar connecting elements and that are used for connecting corresponding multiwire cable conductors. These flexible conductor holders represent only demonstration examples with regard to the type and shape of the particular contact casings as well as their configuration to form specific plug-in connection patterns. In this respect, these examples are neither all-inclusive nor limiting in any way.

The other described details of these flexible conductor holders that are examples only and are neither all-inclusive nor limiting in any way with respect to design, in principle correspond to respective elements of adjacent parts, for example individual parts within a corresponding plug-in connector, sensor, electronic module, or the like. Thus, for example, 19.2, 20.2, 21.2 are stop or mounting surfaces, 19.3, 20.3, 21.3 or 19.4, 20.4, 21.4 are corresponding codings or anti-rotation elements, and 19.5, 20.5, 21.5 are handles or handle-like surfaces.

1. A method of making a contact casing made of plastic and comprising a contact having a press-fit connector for fixing one end of an electrical cable in at least one contact chamber in the contact casing wherein the contact casing is produced in a generative process in such a way that the contact casing is built up in layers from an amorphous starting material by irradiation with light.

2. The method according to claim 1 wherein the starting material is a powder or a liquid.

3. The method according to claim 1 wherein the starting material is a photoreactive polymer.

4. The method according to claim 1 wherein the irradiation is carried out using a controlled, focused light beam, and as a function of CAD data representing the shape of the contact casing to be produced.

5. The method according to claim 1 wherein the irradiation is carried out using ultraviolet light.

6. The contact casing produced according to the method of claim 1.

7. The contact casing according to claim 6 wherein the contact casing is axially generally straight.

8. The contact casing according to claim 6 wherein the contact casing extends along an axis having at least one curve.

9. The contact casing according to claim 6 wherein several contact casings are combined with a contact support to form an assembly, and in each contact casing a press-fit connector is mounted and secured after the contact support has been manufactured.

10. The contact casing according to one of claims 6 through 9 wherein the contact casing has a shape according to FIG. 2, 5, 8, 11, 14, or 17.
